(19) United States
(12) Patent Application Publication
(10) Pub. No.: US 2009/0101638 A1
(43) Pub. Date: Apr. 23, 2009

(54) INDUCTION MODULE, ARRANGEMENT OF SEVERAL INDUCTION MODULES AND METHOD FOR INSTALLING SUCH AN INDUCTION MODULE

(75) Inventors: Ueli Niederer, Weinfelden (CH); Christof Gmuender, Bichwil SG (CH); Sascha Jaeckle, Goldach SG (CH); Benno Jaeckle, Loemmenschwil SG (CH)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: E.G.O. Elektro-Geraetebau GmbH

(21) Appl. No.: 12/248,322

(22) Filed: Oct. 9, 2008

(30) Foreign Application Priority Data
Oct. 12, 2007 (DE) 102007050341

(51) Int. Cl. H05B 6/04; B23P 17/00

(52) U.S. Cl. 219/671; 29/592.1

(57) ABSTRACT

An induction module and an arrangement of several such induction modules is provided, typically having several power electronics modules for controlling in each case at least one induction coil in a housing. A control unit is also provided in the housing. The control unit and the overall arrangement are configured for operation with a synchronization bus system, which is used for connecting to other induction modules in an arrangement.

### CROSS REFERENCE TO RELATED APPLICATIONS

This application claims priority to German Application Number 102007050341 filed on Oct. 12, 2007, the contents of which are incorporated by reference.

### FIELD OF THE INVENTION

The invention relates to an induction module for at least one induction coil as an inductive heating device, an arrangement of several such induction modules and a method for installing such an induction module.

### BACKGROUND OF THE INVENTION

It is known to place several induction coils below a cooking surface or beneath a hob plate, both in the case of induction hobs for private residential (household) equipment and induction cooking equipment for the commercial sector, such as for restaurant equipment. The induction coils are supplied with power by induction modules or power electronics units and are correspondingly controlled. In the case of induction hobs for residential applications, a self-contained functional unit is formed, whereas for the commercial sector, they have a modular structure so as to allow easier replacement, extension or modification. Normally the power electronics or induction modules are designed for the use of specific or differing induction coils, which are characterized by features such as the power consumption and the necessary control.

One problem addressed by the invention is to provide an aforementioned induction module and an arrangement of several such induction modules making it possible to obviate the problems of the prior art and allowing advantageous further developments and in particular an improved cooperation between several such induction modules.

### BRIEF DESCRIPTION OF THE DRAWINGS

The invention is described hereinafter relative to the attached diagrammatic drawings, wherein:

FIG. 1 illustrates a diagrammatic representation of one embodiment of the construction of an induction module with power electronics, control unit and terminals, and

FIG. 2 illustrates another embodiment of an arrangement of several induction modules from FIG. 1 as a cooking device with a common cooking surface.

### DETAILED DESCRIPTION OF THE EMBODIMENTS

This problem is solved in one embodiment by an induction module, an arrangement of several such induction modules, and a method of operation as claimed herein. Advantageous and preferred developments of the invention form the subject matter of the further claims and are explained in greater detail hereinafter. By express reference the wording of the claims is made into part of the content of the present description.

An induction module is provided for at least one induction coil as the inductive heating device and advantageously for several induction coils. An induction module has power electronics for the power supply for the one or more induction coils and a control unit for controlling said power electronics. The power electronics and control unit are placed in a housing of the induction module or are combined within a functional unit. According to one embodiment of the invention, the induction module or control unit have a synchronization bus system for synchronizing or linking said induction module with other induction modules. The advantage of such a synchronization bus system is that several induction modules or their power electronics can be interconnected with the induction coils to form larger, so-to-speak virtual equipment, and then, in certain circumstances, can be jointly controlled or controlled according to common preset details and to which further reference will be made hereinafter.

In another embodiment of the invention, an induction module is constructed without operating or control elements, at least for operational purposes. In the case of an arrangement of several induction modules according to the invention, it is possible that either a separate operating device with operating elements is provided and which is admittedly connected to the induction modules, but is not equipment integrated into the same. Alternatively, an operating device can also be provided on one of many induction modules or on or in its housing. Such an induction module is then a master induction module for the overall arrangement with respect to the other induction modules.

In another embodiment of the invention, it is advantageous if the induction modules are constructed without induction coils, i.e., do not form an equipment unit therewith. Thus, greater flexibility in use is provided regarding the connection and the joint use with random induction coils.

Advantageously, an induction module or its power electronics are constructed for controlling one or more induction coils. An induction module can control a maximum power corresponding to the sum of the maximum powers of the power electronics, for example 5 kW per controlled power electronics, which would lead to an expansion in the case of four channels up to 20 kW controlled by the same induction module. With particular advantage, the power electronics of an induction module is divided up into several power electronics modules, advantageously one power electronics module per induction coil to be controlled. However, in further expansion stages there can be several induction coils per power electronics module. This permits a more flexible construction of an induction module, so that as a function of the desired configuration of induction coils to be connected, corresponding power electronics modules can be used in the induction module. Thus, it is possible to achieve in the induction module a configuration of power electronics modules or the complete power electronics technically and pricewise adapted in optimum manner to a corresponding induction coil configuration.

The synchronization bus system is preferably integrated into the induction module control unit or is provided by the same. Advantageously, use is made of a so-called serial bus system, for example a CAN (Controller Area Network) bus system, to which are added a few signals, whose functionality is considered optimum for the purposes of the present invention. Such a CAN bus system can functionally interconnect a random number of different induction modules and further reference will be made thereto hereinafter.

In a further embodiment of the invention, an induction module can have a service interface for easier and better accessibility. For this purpose, a service attachment plug can for example be provided on the induction module by means of which, following the connection of a corresponding external service device, data can be inputted or read out. Thus, it is for example possible to have a parametrization or adjustment of the control unit or also the power electronics. Thus, specific operating parameters can be subsequently modified, for example as a subsequent adaptation to induction coils linked with the power electronics.

Advantageously, each induction module is provided as an individual module or in an individual housing. Thus, in the case of an inventive arrangement of several such induction modules, a collection of such housings can be provided. Besides the power electronics and a control unit, the housing is provided on one or more control boards with control units for fans for cooling purposes and corresponding connection possibilities in the form of plugs, screw terminals, etc. Advantageously, the housings for all the constructions of induction modules are identical and are then correspondingly equipped, for example, with a different number of power electronics, as a function of the number of induction coils to be controlled with an induction module.

In the case of the inventive arrangement of one or advantageously several induction modules, they have in each case several induction coils or are linked thereto. The induction modules are interconnected by means of a synchronization bus system, which with particular advantage, is a serial bus system. The arrangement also includes at least one operating device with corresponding operating elements, in order to control the induction modules and ultimately the operation of the controlled induction coil. Advantageously, the operating device is positioned remote from the induction modules and connected to an induction module by means of a data connection, which can occur in wireless manner or using cables. The connection is here again advantageously a bus system, with particular advantage a LIN (Local Interconnect Network) bus system, i.e., a bus system with a local interconnect network. By means of operating elements on the at least one operating device, the control unit of each induction module can be correspondingly addressed, and in this way the operation of the induction coils linked therewith controlled, it being possible for an operating device to be connected to an induction module and by means thereof or the synchronization bus system, all the induction modules can be controlled with said single operating device.

There can be several operating devices for several induction modules, namely at different locations. Thus, in the case of a construction with a larger number of induction coils, for example a large heating surface with for example 10 to 20 hotplates, it is possible to carry out operation or adjustment from several positions. This improves handling and practice suitability of such an arrangement or the heating surface formed by it. However, with particular advantage, the operating devices are in the immediate vicinity of the heating surface. In another embodiment of the invention, the induction modules can be further removed from the heating surface or the induction coils. Thus, it is for example possible to locate the induction modules in a separate area within the same building in order to facilitate the noise problem, heat evolution and cooling. With particular advantage, such an arrangement can be a cooking device, i.e. a large hob, where each induction coil can define a hotplate for a saucepan. Other heating devices for inductive heating are also possible, for example with melting furnaces, etc.

An above-described arrangement or also a single induction module can admittedly have identical induction coils. However, advantageously the induction coils are at least in part differently constructed with respect to parameters such as size, output or design, which leads to more universal usability or for heating surfaces of different sizes, for example saucepans of different sizes, as well as different power stages, there is in each case a suitable induction coil as the heat source. With an arrangement as a heating surface or heating device, the induction coils can have a small mutual spacing, for example from a maximum of a few millimetres to particularly less than 4 centimetres. Thus, it is also conceivable for two induction coils to be jointly covered by a single saucepan so as to heat the same. It is unimportant whether such closely juxtaposed induction coils are controlled by one and the same or by different induction modules. One of the main advantages of the interconnection of several induction modules through the synchronization bus system is that they permit a randomly jointly matched, problem-free operation of several induction modules and power electronics with their induction coils.

In regards to the method for installing such an induction module or such an arrangement of several induction modules, by means of the synchronization bus system or the service interface, it is possible to define the cooperation of individual operating elements, induction modules and/or their power electronics. Moreover, according to the invention, it is possible to read out current or past operating data or parameters. Advantageously, it is possible to store an energy management parameters by an interface, so that individual induction modules or also the arrangement thereof only obtain from the supply network a specific total peak output. Thus it is possible to react to preset tariffs or differences with regards to power suppliers thus reducing or avoiding peak consumption levels. It is also possible in this way to reduce or avoid network repercussions or undesirably high reactive power levels, for example as a result of output shifts during the operation of a large number of induction coils. This makes it possible to avoid the need for the hitherto necessary energy optimization installations of separate manufacturers, which have had to be connected in a complicated manner to the existing inductive cooking devices and as a result the energy distribution process can be optimized.

These and further features can be gathered from the claims, description and drawings and the individual features, both singly and in the form of subcombinations, can be implemented in an embodiment of the invention and in other fields and can represent advantageous, independently protectable constructions for which protection is claimed here. The subdivision of the application into individual sections and the subheadings in no way restrict the general validity of the statements made thereunder.

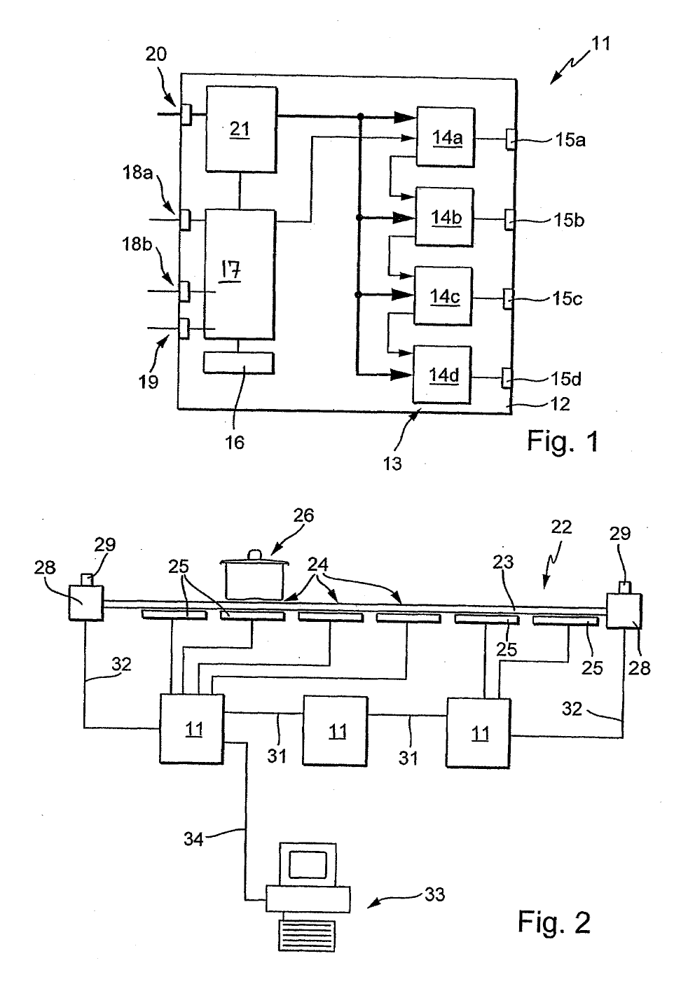

FIG. 1 diagrammatically shows the construction of an inventive induction module 11. In a housing 12 the power electronics 13 are placed on the right-hand side, comprising four power electronics modules 14a-14d. They can have an identical construction, but this need not required and in certain circumstances they can be constructed for different outputs and as a result have different sizes. Each power electronics module 14a-14d is provided with a connection or terminal 15a-15d on housing 12, to which can be connected one or more induction coils. The maximum output or power of a power electronics module 14a-d can be as much as 5 Kw. A fan 16 is shown in FIG. 1 and is able to cool the power electronics 13, as well as all the equipment in the housing.

The housing 12 of induction module 11 also contains a control unit 17, particularly with a correspondingly equipped microprocessor. The control unit 17 has a control connection or terminal 18a for the LIN bus system, particularly in the form of a plug-in connection, a control connection 18b for the CAN bus system and a service connection 19, advantageously also a plug-in connection. By means of the control connection 18a, the induction module 11 is controlled from the outside, particularly also with operating instructions for the operation of the induction module 11 or power electronics modules 14a-14d, together with the connected induction coils. The induction module 11 is connected to other induction modules by means of the control connection 18b.

As can be seen, induction module 11 has neither fitted in or directly fastened induction coils, nor an operating device or operating elements. It is admittedly possible for there to be operating elements in the form of switches or power mains isolation switches, but these are not for the power adjustment of the power electronics 13 or for such comparable functions such as the correct operation as a heating or cooking device.

There is also a power mains connection 20 and a unit 21 formed by a mains filter, rectifier and low voltage supply for control unit 17. Said unit supplies the necessary electrical power from the mains voltage delivered to the induction coils after conversion by the electronics modules 14a-14d.

FIG. 2 shows an arrangement 22, where beneath a cooking surface 23 there are several induction coils 25, which in each case form a hotplate 24. Said cooking surface 23 can for example be made of glass ceramic material and in certain circumstances can be subdivided into several individual areas. The induction coils 25 have a conventional construction, advantageously constituting flat coils, which are fixed beneath the cooking surface 23. On a hotplate 24 is for example placed a saucepan 26, so that by means of the induction coil 25 beneath the same to be subject to inductive heating.

The arrangement or cooking device 22 has two operating devices 28, one on each side and which in each case have operating elements 29, for example rotary toggles or alternatively touch switches. There can also be more operating devices 28.

The operating devices 28 are in each case connected by a connection 32 to an induction module 11. Said connection 32 can be constructed as or incorporate an aforementioned bus system, advantageously a LIN bus system. This is responsible for the communication of the operating devices 28 with induction modules 11 via a bus, for example a LIN bus system 32. The communication between the individual induction modules 11 takes place by means of a synchronization bus system, advantageously a CAN bus system, constituting connection 31. This can also bring about the aforementioned installation or programming of the induction modules, representing the aforementioned important advantages of the invention.

The induction modules 11 are connected via terminals or connections 15 with in each case four induction coils 25 and the cooking surface 23, but this is not shown for all the induction modules 11. The distance between the induction modules 11 and induction coils 25 can be relatively small, for example a few centimetres, particularly approximately 10 to 40 cm, if the induction modules 11 are positioned directly beneath the same. Alternatively the distance can also be a few metres, so that the induction modules 11 are for example located in a separate area or room and their cooling and possible noise generation causes no problems.

FIG. 2 shows how a service PC is connected by means of a connecting cable 34 to a service connection 19 of the left-hand induction module 11 and consequently to its control unit. With said service PC there can be a certain reconfiguration or reprogramming of a control unit 17 or the corresponding induction module 11. In addition, operating data collected in the control unit 17 with respect to the operation can be read out, for example in order to be able to identify and avoid any faults or errors as early as possible, in order to determine service intervals or to permit more rapid identification of faulty parts.

The number of induction modules 11 in the arrangement 22 according to FIG. 2 can vary, but generally there are 5 to 10 induction modules, within each case, four connected induction coils are typically adequate for many purposes.

It is also possible within the arrangement 22 or within the induction modules 11 to define a preferred or master induction module, which then can mainly control the synchronization bus system of the CAN bus system.

1. An induction module for at least one induction coil for operating together as an inductive heating device, said induction module comprising:
a power electronics for supplying power for said at least one induction coil; and
a control unit for controlling said power electronics, wherein said power electronics and said control unit are combined into a functional unit, wherein said control unit has a synchronization bus system for synchronizing and connecting said induction module to additional corresponding induction modules.

2. The induction module according to claim 1, constructed without any operating elements for a user.

3. The induction module according to claim 1, constructed without an induction coil.

4. The induction module according to claim 1, wherein said power electronics is configured for controlling several said induction coils with a total output power corresponding to a sum of individual powers of said power electronics.

5. The induction module according to claim 1, wherein said power electronics comprises a plurality of power electronics modules.

6. The induction module according to claim 1, wherein said control unit has a synchronization bus system, constructed as a serial bus system comprising a CAN bus system, said synchronization bus system configured for being expandable with additional control lines for addition of said induction modules top be controlled by said control unit.

7. The induction module according to claim 1, comprising a service interface with a service attachment plug on said induction module for inputting or outputting data.

8. The induction module according to claim 1, located with said power electronics and said control unit in an individual housing.

9. The induction module according to claim 8, wherein there is also at least one fan provided in said housing.

10. A system comprising:
a plurality of induction modules, wherein each induction module comprises
a power electronics for supplying power for said at least one induction coil;
a control unit for controlling said power electronics, wherein said power electronics and said control unit combined into a functional unit, wherein said control unit has a synchronization bus system for synchronizing and connecting said induction module to additional corresponding induction modules; and
a plurality of induction coils, wherein each said induction module is associated with at least one of said induction coils, said induction modules being interconnected by means of a synchronization bus system being configured as a serial bus system or as a CAN bus system, wherein at least one operating device with operating elements for a user is provided for controlling said power supply and for said control unit, said operating device being connected to said induction module or its control unit.

11. The system according to claim 10, wherein there are a plurality of said operating devices for said plurality of induction modules provided at different locations from one another.

12. The system according to claim 11, wherein said plurality of said induction modules are positioned several metres from said induction coils in the same building.

13. The system according to claim 10, constructed as a cooking device wherein said plurality of induction coils are located in a single plane and are essentially forming a cooking surface with several hotplates.

14. The system according to claim 10, wherein at least some of said plurality of induction coils are mutually spaced from each other by a maximum of 40 mm.

15. A method for installing an induction module wherein said induction module comprises
a power electronics for supplying power for said at least one induction coil, and
a control unit for controlling said power electronics, wherein said power electronics and said control unit are combined into a functional unit, wherein said control unit has a synchronization bus system for synchronizing and connecting said induction module to additional corresponding induction modules,
wherein a cooperation of each of said induction modules or their respective power electronics is defined by means of said synchronization bus system.

16. The method according to claim 15, wherein current or past operating data or parameters of said induction modules or their respective power electronics are read out.

17. The method according to claim 15, wherein at a service interface of said induction module with a service attachment plug on said induction module for parameterizing said control unit and for diagnosis of said power electronics, data is inputted and read out.

18. The method according to claim 15, wherein an energy management is stored in said induction module in such a way that one said induction module or said arrangement of said induction modules only acquires a maximum total peak power output from said induction module supply mains in order to reduce or avoid mains repercussions or undesirably high reactive power levels as a result of output shifts during an operation of a large number of said induction coils.
